(19) United States
(12) Patent Application Publication
(10) Pub. No.: US 2026/0297984 A1
(43) Pub. Date: Oct. 1, 2026

(54) MOTOR VEHICLE LATCH

(71) Applicant: Kiekert Aktiengesellschaft, Heiligenhaus (DE)

(72) Inventors: Robert Hunt, Davisburg, MI (US); David Taylor, Livonia, MI (US)

(73) Assignee: Kiekert Aktiengesellschaft, Heiligenhaus (DE)

(21) Appl. No.: 19/089,112

(22) Filed: Mar. 25, 2025

(51) Int. Cl. E05B 77/04; E05B 79/04; E05B 85/24

(52) U.S. Cl. CPC E05B 77/04; E05B 79/04; E05B 85/243

(57) ABSTRACT

The object of the invention is a motor vehicle latch, and in particular a motor vehicle door latch. In its basic structure, this is equipped with a lock plate for mounting a locking mechanism made of substantially a catch and pawl. In cross section, the lock plate has at least one raised L-leg as a stop. In addition, the catch is equipped with an extension for interaction with the stop. According to the invention, the extension formed integrally with the metal catch is supported on the stop when the locking mechanism a locked state and at least in the event of a crash.

The invention relates to a motor vehicle latch, in particular a motor vehicle door lock, having a lock plate for mounting a locking mechanism consisting essentially of a catch and a pawl, wherein the lock plate has at least one upright L-leg as a stop in cross section, and wherein the catch is equipped with an extension for interaction with the stop.

In a motor vehicle latch as has become known by DE 103,20,440 A1, the locking mechanism consisting substantially of a catch and pawl is accommodated in a lock case. A reinforcing element for the locking mechanism is also provided. The reinforcing element has a lateral projection with respect to the housing, which extends substantially in the opposite direction in comparison with a possible impact direction. This is intended to improve crash safety overall, particularly in the event of a side impact.

In fact, such a crash generally results in tearing forces acting on the locking mechanism. These are transmitted via a locking pin held in the locking state of the locking mechanism. For this purpose, the locking pin is generally connected to a body while the motor vehicle latch is located in the door or hatch.

The aforementioned tearing forces are substantially accompanied by forces extending in or against a potential impact direction. In this case, it may be the Y or vehicle transverse direction if one assumes a side impact, as is described in the aforementioned document DE 103,20,440 A1. The projection of the reinforcing element is realized for this purpose in the known teaching. This is intended to provide optimal support of the axles or bearing pins bearing the catch and the pawl. This has proven itself in principle, but on the one hand requires a specially designed reinforcing plate and, on the other hand, the mentioned projection. Such a projection is not always advantageous in view of the restricted space conditions observed at this point and typically provided.

DE 10,2009,029,025 A1 also relates to a motor vehicle latch which is equipped with a lock case and a locking mechanism comprising a catch and pawl mounted therein. In addition, a means for transmitting force to the lock case is also provided. This is a bolt which depicts an additional stop for the catch. The latch can be used to limit the rotary movement of the catch from an open position beyond the main detent position. The latch is generally located in the interior of the lock case and does not extend to a lateral wall of the lock case. Such a design requires an additional processing step of the lock case and is thus disadvantageous in terms of manufacturing.

In the motor vehicle latch according to DE 10,2020, 106,592 A1, the procedure is such that at least one locking mechanism component is equipped with a support element. In the closed state of the locking mechanism, the support element rests against the latch case and/or a reinforcing plate as a structural component. In this case too, an additional equipping of the lock case or the lock plate in the interior is necessary because the support element is generally arranged remote from the axis in comparison with the axis of the associated locking mechanism component.

The motor vehicle door lock according to utility model specification DE 20,2005,010,526 A1 is equipped with a locking mechanism damper that completely or partially enters the movement path of the locking mechanism. A damping effect is thereby achieved both in the opening and closing direction of the locking mechanism. This is intended to reduce noise generation. Any problems with regard to crash safety do not play a role.

In the generic prior art according to DE 10,2007,049,676 A1 representing the starting point, the procedure is such that the catch is supported on the lock housing with the interposition of a deformable element. This takes place in the locking position. The deformable element is a thermoplastic plastic part produced with oversize. When the lock is closed for the first time, the plastic part is shrunk to fit by heating. This is intended to avoid any rattling noises. Problems of crash safety are not addressed.

The invention is based on the technical problem of further developing such a motor vehicle latch and in particular a motor vehicle door latch in such a way that crash safety is increased while at the same time simplifying the design.

To solve this technical problem, the invention proposes, starting from a generic motor vehicle latch and in particular a motor vehicle door lock, that the extension, which is formed integrally with the metal catch, is supported against the stop in a locked state of the latch and at least in the event of a crash.

In contrast to the generic prior art according to DE 10,2007,049,676 A1, an extension made of plastic is therefore expressly not provided on the catch in order to prevent rattling noises. Rather, the catch itself is metallic and integrally formed with the extension which consequently also consists of metal. High-strength steel is usually used here. The same applies to the pawl and also the lock plate in order to be able to properly absorb the forces and, in particular, crash forces acting on the motor vehicle latch according to the invention.

In fact, such crash forces act on the motor vehicle latch according to the invention in such a way that this causes the locking mechanism, which is in the closed or locking state, to typically be loaded further in the closing direction. Loading in the opening direction is also possible. Either way, the crash forces are associated with the fact that the catch is subjected to additional rotational loading by the locking bolt it captures in the event of a crash. Such an additional rotation starting from the locking state or the closed position of the locking mechanism is now prevented or absorbed according to the invention in that the extension formed integrally with the metal catch is supported on the stop of the lock plate in said locked state of the locking mechanism and at least in the event of a crash.

This support of the catch via the extension on the stop of the lock plate can in principle also take place when the locking mechanism is already in a locked state. When the locking mechanism is in a locked state, however, an at least slight gap is generally observed between the extension on the one hand and the stop of the lock plate on the other hand. This gap is closed at least when a crash occurs and the associated crash forces act on the catch and additionally subject it to a rotational load. Since in this context, according to the invention, the continuous metal catch including extension interacts with the stop of metal, which is typically also integrally formed with the lock plate, particularly high crash forces can be absorbed and mapped in this way. This prevents accidental and avoidable lock openings so that crash safety is increased.

At the same time, this is achieved with a simplified structure because both the upright L-leg on the metal lock plate and the extension of the metallic catch are each formed integrally. As a result, the L-leg can be integrated directly as a stop, just like the extension, in the manufacturing process of the lock plate or the catch, and additional machining or manufacturing steps are unnecessary. This reduces the manufacturing effort and consequently also the costs. These are the main advantages.

In order to increase the crash safety overall, a reinforcing plate can additionally be provided as a reinforcing element. The reinforcing plate thereby couples both a bearing pin for the pawl and the catch, namely with the lock plate. That is to say, a stiffening of the lock plate is achieved via the reinforcing plate, because the lock plate, including the reinforcing plate and the two bearing pins, describes an overall box-like shape which is particularly torsionally rigid and can thus absorb high crash forces.

In this context, it has proven useful if the reinforcing plate is L-shaped in plan view with a pawl arm and a catch arm. The pawl arm has an opening in which the bearing pin engages for the rotatable mounting of the pawl. The catch arm is in turn equipped with a further opening via which the bearing pin for the rotatable mounting of the catch is coupled to the reinforcing plate. Both bearing pins are in turn anchored in the lock plate.

In this way, the lock plate with its base surface and the reinforcing plate predominantly running predominantly parallel thereto form the already mentioned box or the box structure. This is completed by the bearing pin connecting the reinforcing plate and the lock plate to one another for the catch on the one hand and the pawl on the other hand. For this purpose, the bearing pins are each fixedly anchored in the lock plate on the one hand and in the reinforcing plate on the other hand. In this regard, it is advantageously possible to work with rivet connections. In principle, welded connections or other types of connection are also conceivable in this context.

As already explained, the catch arm has an opening receiving the bearing pin of the catch. This opening is advantageously arranged above an inlet mouth for a locking pin. This holds true at least in a plan view of the locking mechanism or the lock plate. In contrast, the extension of the catch is arranged below the inlet mouth when the locking mechanism is in a locked state. The extension lies flat against the stop with a blunt contact contour at least in the event of a crash. This means that due to the blunt character of the contact contour on the extension of the catch, there is a flat contact between the contact contour in question on the one hand and the stop on the other so that particularly high forces can be transmitted via the extension and the stop in the event of a crash, without any notch effect.

The design is advantageously such that the opening in the catch arm arranged above the inlet mouth for the locking pin, the locking pin accommodated in the inlet mouth, and finally the contact contour arranged below the inlet mouth describe a triangle overall. This triangle advantageously represents a component of a parallelogram of forces.

In this parallelogram of forces, the crash force is arranged to run in extension of the inlet mouth. This crash force running in extension of the inlet mouth acts on the locking pin or also on the lock plate. In any case, the crash force results in the catch being rotated beyond its assumed closed position in the event of a crash, for example so that the extension on the catch moves against the stop in said crash and is supported on the stop. As a result, the crash forces or the crash force associated with the crash are introduced and received via the lock plate into the associated motor vehicle door or motor vehicle hatch and associated therewith, the motor vehicle body as a structural component.

Specifically, the overall design is such that the crash force in question is divided into a first supporting force absorbed by the bearing pin of the catch and a second supporting force introduced into the stop via the extension. The parallelogram of forces already mentioned is thereby formed. This parallelogram of forces is equipped with the diagonal crash force, whereas the first and second supporting force define the respective sides of the parallelogram of forces, as will be explained in more detail below with reference to an embodiment.

As a result, a motor vehicle latch is provided which has increased crash safety compared to the prior art. On the one hand, this can be explained by the large-surface contact of the extension on the catch at the stop in the event of a crash. In addition, and on the other hand, this can be explained by further stiffening being provided in the event of a crash via the optionally provided reinforcing plate and the division of the crash force into the first and second supporting forces. These are the main advantages.

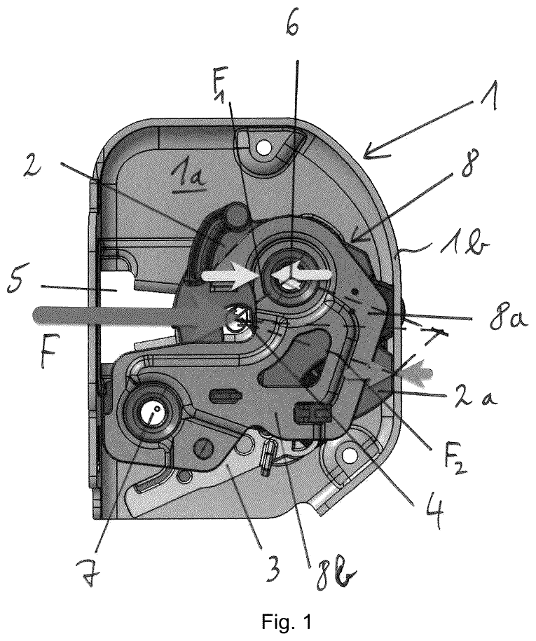

The invention is explained in greater detail below with reference to a drawing which shows only one embodiment. The only FIG. 1 schematically shows a plan view the motor vehicle latch according to the invention in the form of a motor vehicle door lock.

In FIG. 1, a motor vehicle latch and in particular a motor vehicle door lock is shown. In its basic design, this initially has a lock plate 1 for mounting a locking mechanism 2, 3 made of substantially a catch 2 and pawl 3. It can be seen that the lock plate 1 is not only made of metal, for example, a high-strength steel, but also has, in addition to a base plate or base surface 1a, an almost continuous circumferential edge 1b. As a result, the lock plate 1 is equipped with at least one raised L-leg as a stop 1 b in cross section. The catch 2 has an extension 2a.

In the shown locked state or closed state of the locking mechanism 2, 3, a locking pin 4 is held by means of the catch 2. In this case, the locking pin 4 can enter into the locking mechanism 2, 3 in its open state via an inlet mouth 5 in the lock plate 1, and then in the usual way ensures that the catch 2 is pivoted counterclockwise during this process in the closed state shown here, wherein the closed state is secured with the aid of the latching latching pawl 3.

The catch 2 is rotatably received in the lock plate 1 by means of a bearing pin 6. Another bearing pin 7 provides the rotatable bearing of the pawl 3. For this purpose, both bearing pins 6, 7 are anchored in the base surface 1a of the lock plate 1 and extend substantially perpendicular thereto. The fixation of the relevant bearing pin 6, 7 can thereby be produced by a rivet connection, by welding or also in some other way.

In addition, a reinforcing plate 8 is also realized which is also coupled to the two bearing pins 6, 7. In this case too, the coupling may be produced via a rivet connection, a welded connection or the like. The reinforcing plate 8 runs predominantly parallel to the base surface 1a.

For this purpose, the reinforcing plate 8 is equipped with respective openings and penetrated by a head of the relevant bearing pin 6, 7. It can be seen that the reinforcing plate 8 is L-shaped in plan view. A catch arm 8a on the one hand and a pawl arm 8b on the other hand are thereby observed. The catch arm 8a is equipped with the opening for receiving the head of the bearing pin 6 of the catch 2. In contrast, the pawl arm 8b has a corresponding opening for receiving the head of the bearing pin 7 for the pawl 3.

According to the invention and of particular importance is the fact that the extension 2a, which is formed integrally with the metal catch 2, is supported on the stop 1b in the illustrated locked state of the locking mechanism 2, 3 and in the event of a crash. According to the embodiment, both the catch 2 as well as the pawl 3 and the lock plate 1 are each metal and in particular made of a high-strength steel. The crash case now corresponds to the fact that a crash force F indicated in FIG. 1 acts on the catch 2 which, according to the exemplary embodiment, ensures that the catch 2 is rotated further in the counterclockwise direction starting from the illustrated locked state of the locking mechanism 2, 3. According to the invention, such a further rotational movement from the crash force F is prevented or absorbed by the extension 2a of the catch 2 being supported against said stop 1b.

Since the lock plate 1 in turn is connected to a motor vehicle door or a motor vehicle body, the crash force F is consequently introduced via the extension 2a, the stop 1 b, ultimately into the body of the motor vehicle, which is not shown, and is dissipated here. According to the invention, this is particularly effective in that the optional reinforcing plate 8 is additionally provided. This is because the lock plate 1, which is designed as a lock case, in conjunction with the reinforcing plate 8, which runs parallel to the base surface 1a of the lock plate 1, and the two bearing bolts 6, 7 together define a box-like supporting structure 1, 6, 7, 8. This box-like support structure 1, 6, 7, 8 is particularly torsionally rigid. In addition, a particularly effective introduction of the crash force F into the lock plate 1 and therefore ultimately into the body of the motor vehicle is provided in this way.

For this purpose, the catch arm 8a is equipped with the opening receiving the bearing pin 6 for the catch 2 above the inlet mouth 5 for the locking pin 4. Furthermore, when the locking mechanism is in the shown locked state 2, 3, the extension 2a of the catch 2 is below the relevant inlet mouth 5, specifically in plan view. The extension 2a is in turn equipped with a blunt contact contour which rests flat against the stop 1b at least in the event of a crash. I.e., in the illustrated locked state of the locking mechanism 2,3, a (slight) gap may be observed between the extension 2a on the one hand and the stop 1b on the other, which is closed at least when the catch 2 is pivoted further in the direction of its closed position in the counterclockwise direction with the aid of the crash force F, and thereby causing the extension 2a to lie flat against the stop 1 b with its blunt contact contour.

The opening for the locking pin 6 of the catch 2 in the catch arm 8a, the locking pin 4, and finally the contact contour 2a, defines a triangle overall. This triangle is designed as a component of a parallelogram of forces indicated in FIG. 1. The parallelogram of forces has a diagonal which corresponds to the crash force F running in extension of the inlet mouth 5. This crash force F works according to the exemplary embodiment and non-restrictively on the locking pin 4.

In fact, it can be seen from the indicated force parallelogram that the crash force F is divided into a first supporting force F₁ absorbed by the bearing pin 6 of the catch 2 and a second supporting force F₂ introduced via the extension 2a into the stop 1 b. As a result, the crash force F is introduced particularly effectively into the lock plate 1 and therefore ultimately into the body of the associated motor vehicle. That is because, in the end, this is done via the two supporting forces F₁, F₂, which are arranged at an angle to each other. In fact, in the exemplary embodiment, the two supporting forces F₁, F₂ define an angle of 30 to 90° between them, according to the exemplary embodiment, an angle of about 60°. Of course, this is by no means limiting.

### LIST OF REFERENCE NUMBERS

Lock plate 1
Base plate 1a
Base surface 1a
Stop 1b
Edge 1B
Locking mechanism 2, 3
Catch 2
Extension 2a
Pawl 3
Locking pin 4
Inlet mouth 5
Support structure 1, 6, 7, 8
Bearing pin 6
Bearing pin 7
Rotary latch arm 8a
Pawl arm 8b
Crash force F
Supporting force F₁, F₂

1. A motor vehicle latch, comprising:
a locking mechanism including a catch and a pawl, and
a lock plate for mounting the locking mechanism and having an inlet mouth for receiving a locking pin,
wherein the inlet mouth extends in a first direction from an open end of the entry area to a closed end of the entry area,
wherein the lock plate has at least one upright L-leg as a stop in cross section,
wherein the catch includes an extension for interacting with the stop,
wherein the extension is integrally formed with the catch, and
wherein the extension is supported on the at cast one-stop when the locking mechanism is in a locked state and in the event of a crash,
wherein a rotational axis of the catch is on a first side of a plane extending along the first direction and the extension of the catch is arranged on a second side of the plane when the locking mechanism is in the locked state.

2. The motor vehicle latch according to claim 1, further comprising a reinforcing plate.

3. The motor vehicle latch according to claim 2, further comprising a first bearing pin for the catch and a second bearing pin for the pawl, wherein the reinforcing plate couples both the first bearing pin and the second bearing pin to the lock plate.

4. The motor vehicle latch according to claim 3, wherein the reinforcing plate is L-shaped in plan view, and wherein the reinforcing plate includes a catch arm and a pawl arm.

5. The motor vehicle latch according to claim 4, wherein
the catch arm has an opening for the first bearing pin for the catch above the inlet mouth for the locking pin.

6. (canceled)

7. The motor vehicle latch according to claim 5, wherein the extension has a blunt contact contour, and wherein the extension rests flat against the stop with the blunt contact contour in the event of a crash.

8. The motor vehicle latch according to claim 7, wherein the opening in the catch arm, the locking pin, and the blunt contact contour describes a triangle.

9. The motor vehicle latch according to claim 8, wherein the triangle is designed as a component of a parallelogram of forces with a crash force running in extension of the inlet mouth and acting on the locking pin, in the event of a crash.

10. The motor vehicle latch according to claim 9, wherein the crash force is divided into a first supporting force absorbed by the first bearing pin of the catch and a second supporting force introduced into the stop via the extension of the catch.

11. The motor vehicle latch according to claim 1, wherein the catch is made of metal.

12. The motor vehicle latch according to claim 9, wherein the parallelogram of forces includes the crash force defining a diagonal force and the first and second supporting forces defining respective sides of the parallelogram of forces.

13. The motor vehicle latch according to claim 3, wherein the first and second bearing pins are each fixedly anchored in the lock plate on the one hand and in the reinforcing plate on the other hand.

14. The motor vehicle latch according to claim 7, wherein the blunt contact contour is arranged below the inlet mouth.

15. A motor vehicle latch, comprising:
a locking mechanism including a catch and a pawl, and
a lock plate for mounting the locking mechanism,
wherein the lock plate has at least one upright L-leg as a stop in cross section,
wherein the catch includes an extension for interacting with the stop,
wherein the extension is integrally formed with the catch,
wherein the extension is supported on the stop when the locking mechanism is in a locked state and in the event of a crash,
further comprising a reinforcing plate,
further comprising a first bearing pin for the catch and a second bearing pin for the pawl, wherein the reinforcing plate couples both the first bearing pin and the second bearing pin to the lock plate,
wherein the first and second bearing pins are each fixedly anchored in the lock plate on the one hand and in the reinforcing plate on the other hand.
